(19) United States
(12) Patent Application Publication
(10) Pub. No.: US 2026/0370652 A1
(43) Pub. Date: Nov. 19, 2026

(54) Cloud-Based Geographic Internet Protocol (IP) Address Brokering

(71) Applicant: Zscaler, Inc., San Jose, CA (US)

(72) Inventors: Girish Kumar Attimgere Lingaiah, San Jose (CA); Ravinder Verma, Fremont, CA (US); Thilak Raj Surendra Babu, San Jose, CA (US); Thekkar Nishanth Prabhu, Sunnyvale, CA (US)

(73) Assignee: Zscaler, Inc., San Jose, CA (US)

(21) Appl. No.: 19/207,472

(22) Filed: May 14, 2025

(51) Int. Cl. H04L 9/40

(52) U.S. Cl. CPC H04L 63/107

(57) ABSTRACT

Systems and methods include receiving, at a processing node located in a first geographic region, a request from a user to access a network resource, wherein the request from the user is directed to a cloud-based system for inline inspection prior to reaching the network resource; determining a second geographic region associated with the user; selecting an internet protocol (IP) address registered to the second geographic region; and brokering a connection to the network resource by transmitting the request using the selected IP address as a source IP address.

### FIELD OF THE DISCLOSURE

The present disclosure relates generally to networking and computing. More particularly, the present disclosure relates to cloud-based geographic internet protocol (IP) address brokering.

### BACKGROUND OF THE DISCLOSURE

As enterprises increasingly adopt distributed cloud-based architectures to route and secure user traffic across global networks, the geographic location of both users and traffic-handling nodes plays a role in determining access permissions, content rendering, and compliance with regional regulations. Traditional network security models often lack the ability to account for regional restrictions at the Internet Protocol (IP) level when forwarding traffic across geographic borders. When cloud-based security systems intercept and broker user connections through remote processing nodes, the source IP address used in such connections may no longer reflect the geographic region associated with the original user request. As a result, users may experience access denials when attempting to reach geographically restricted content, or may be served localized content, such as language, advertisements, or service interfaces, that does not match their actual region. This mismatch between user location and perceived IP origin disrupts the user experience and can create obstacles in accessing region-sensitive applications or resources. In many cases, existing cloud-based security systems are unable to ensure that user traffic maintains its regional fidelity when routed through the nearest available node, particularly in regions where physical infrastructure is geographically concentrated. Accordingly, there exists a need for improved systems that enable processing nodes to dynamically determine the geographic origin of user traffic and broker access to resources using IP addresses that are registered to the user’s region. Such systems must maintain compliance with local regulations, preserve the intended user experience, and ensure that secure access to internet and Software as a Service (SaaS)-based resources remains seamless across geographic boundaries.

### BRIEF SUMMARY OF THE DISCLOSURE

In an embodiment, a method, instructions in a non-transitory computer-readable storage medium, and a cloud-based system are presented to perform steps. The steps include receiving, at a processing node located in a first geographic region, a request from a user to access a network resource, wherein the request from the user is directed to the cloud-based system for inline inspection prior to reaching the network resource; determining a second geographic region associated with the user; selecting an internet protocol (IP) address registered to the second geographic region; and brokering a connection to the network resource by transmitting the request using the selected IP address as a source IP address.

The processing node can be selected by the cloud-based system to receive the request based on geographic proximity between the processing node and the user. The determining can include evaluating an original source internet protocol (IP) address associated with the request from the user. The determining can include evaluating an original source internet protocol (IP) address associated with the request from the user. The IP address can be selected from a pool of IP addresses, wherein each IP address in the pool is registered to a geographic region. The pool of IP addresses can include tenant-specific sub-pools, and the IP address can be selected from a tenant-specific sub-pool based on an identifier associated with the user. The selected IP address can be hosted at the processing node in the first geographic region, wherein the first geographic region is different from the second geographic region. The steps can further include intercepting, by the processing node, return traffic from the network resource addressed to the selected IP address; and forwarding the intercepted return traffic to the user. The steps can further include maintaining, by the cloud-based system, a plurality of pools of internet protocol (IP) addresses, wherein each IP address from the plurality of pools is registered to a respective geographic region prior to receiving the request from the user. The steps can further include performing, by the processing node, an egress network address translation (NAT) to substitute the original source IP address associated with the request from the user and corresponding to the second geographic region with the selected IP address registered to the second geographic region, prior to brokering the connection to the network resource. The steps can further include rerouting the request to a new processing node upon failure or unavailability of the processing node, wherein the new processing node performs the determining, selecting, and brokering.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of a cloud-based system offering security as a service;

FIG. 1B is a logical diagram of the cloud-based system operating as a zero-trust platform;

FIG. 1C is a logical diagram illustrating zero trust policies with the cloud-based system and a comparison with the conventional firewall-based approach;

FIG. 2 is a network diagram of an example implementation of the cloud-based system;

FIG. 3 is a network diagram of the cloud-based system illustrating an application on the user devices with users configured to operate through the cloud-based system.

FIG. 4 is a block diagram of a server that may be used in the cloud-based system, in other systems, or standalone;

FIG. 5 is a block diagram of a user device that may be used with the cloud-based system or the like;

FIG. 6 is a network diagram of the cloud-based system with various tunnels, labeled as cloud tunnels, for forwarding traffic;

FIG. 7A is a network diagram illustrating multiple geographically distributed enforcement nodes of the cloud-based system and respective geographic regions associated with users connected thereto;

FIG. 7B is a block diagram illustrating a plurality of pools of IP addresses maintained at each enforcement node; and

FIG. 8 is a flow chart of a process for cloud-based geographic internet protocol (IP) address brokering.

### DETAILED DESCRIPTION OF THE DISCLOSURE

Again, the present disclosure relates to cloud-based geographic internet protocol (IP) address brokering. Various embodiments provide systems and methods that enable region-specific brokering of internet access requests by selecting IP addresses based on the geographic region associated with the user, even when the user's traffic is processed at a geographically distinct enforcement node within a cloud-based system.

In conventional cloud-based security infrastructures, user traffic is typically routed through centralized or distributed processing nodes. However, these nodes may handle user requests using IP addresses that are registered to the geographic regions of the processing nodes themselves, rather than to the geographic regions associated with the users from whom the requests originated. As a result, network resources and applications that rely on source IP geolocation may deliver regionally mismatched content or deny access altogether, due to perceived geographic incongruity between the source IP address and regional access policies. This can negatively impact user experience by rendering content in an unintended language, displaying irrelevant advertisements, or triggering access restrictions imposed by regional access controls or regulatory frameworks.

For example, consider a user located in Bogotá, Colombia who is attempting to access a local e-commerce platform through the existing cloud-based security system. The user’s request is routed through a processing node situated in Miami, United States. Due to the IP address associated with the Miami-based node being used as the source IP for the request, the e-commerce platform interprets the request as originating from the United States. As a result, the platform renders content in English, displays U.S.-centric pricing and advertisements, and may even restrict purchases of region-specific goods, thereby degrading the user experience and limiting access to localized services.

In another scenario, a user in Warsaw, Poland attempts to access a government pension portal restricted to requests originating within Polish IP address ranges. However, because the user’s organization relies on the existing cloud-based security system whose nearest processing node is located in Frankfurt, Germany, the request is assigned a German-registered IP address. Consequently, the portal denies access based on geographic policy enforcement, despite the user’s legitimate intent and origin. Such mismatches can disrupt access to critical public-sector resources, particularly where national regulations or compliance mechanisms require strict adherence to location-specific access criteria.

To address these challenges, the present disclosure introduces systems and methods for maintaining IP address locality with respect to the geographic region associated with the user, even when the user's network traffic is processed at a geographically distinct enforcement node. In one embodiment, the disclosed cloud-based system includes a plurality of processing nodes distributed across multiple geographic regions. Each processing node maintains a plurality of pools of internet protocol (IP) addresses, wherein each pool is registered to a different geographic region. Furthermore, each pool may include tenant-specific sub-pools, enabling policy-based IP address assignment in multi-tenant environments.

Upon receiving a request from a user, a processing node of the cloud-based system determines a geographic region corresponding to the user, such as by evaluating the original source IP address of the request. Based on this determination, the processing node selects an IP address from a pool of IP addresses that is registered to the geographic region of the user. Moreover, the processing node then brokers a connection to the destination network resource using the selected IP address as the source IP address for the outbound request. In this manner, the IP address used for routing is geographically consistent with the origin of the user, despite the processing node's own physical location.

By enabling geographic IP address localization within a distributed cloud infrastructure, the present disclosure allows organizations to enforce regional access controls, support localized content rendering, and comply with jurisdiction-specific regulations. Moreover, by incorporating tenant-specific sub-pools within each geographic IP pool, the system further supports granular policy isolation across enterprise tenants. As a result, the disclosed solution enables secure, compliant, and geographically aligned traffic brokering.

### Example cloud-based system architecture

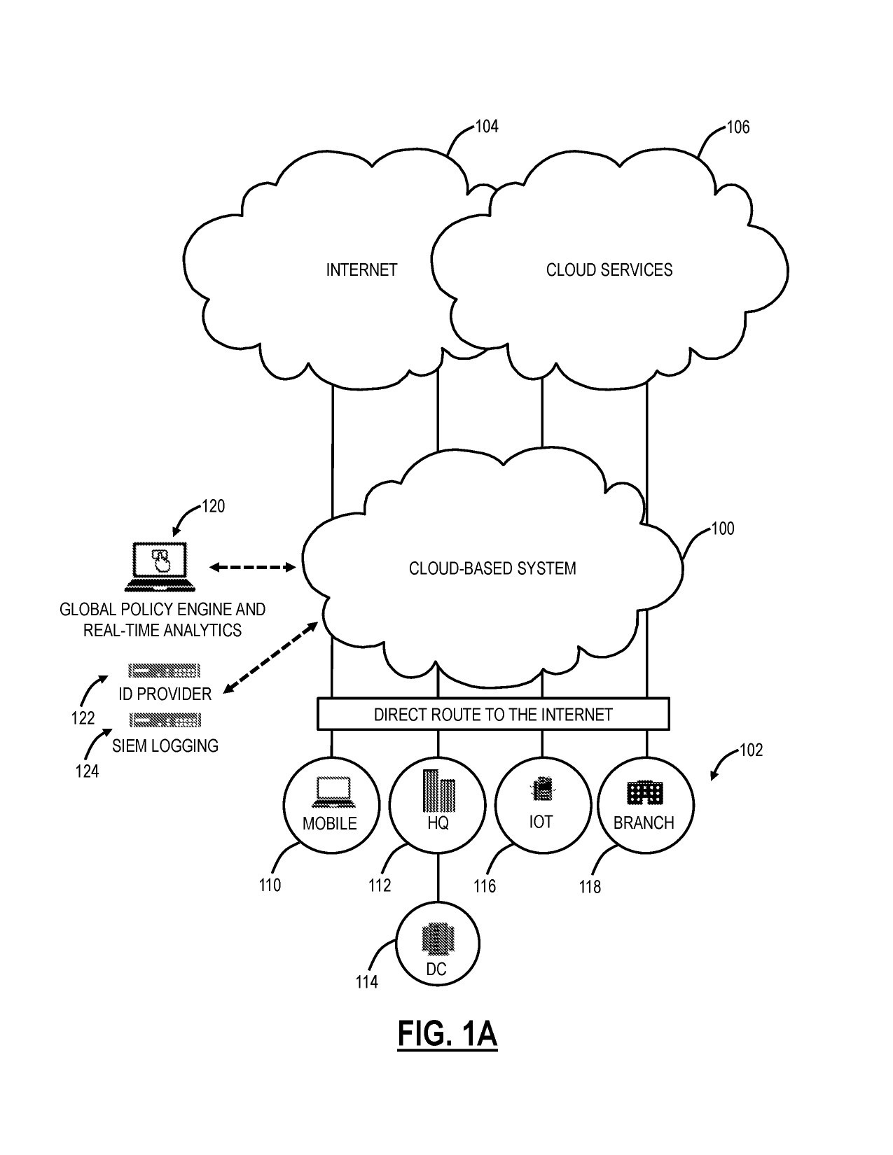

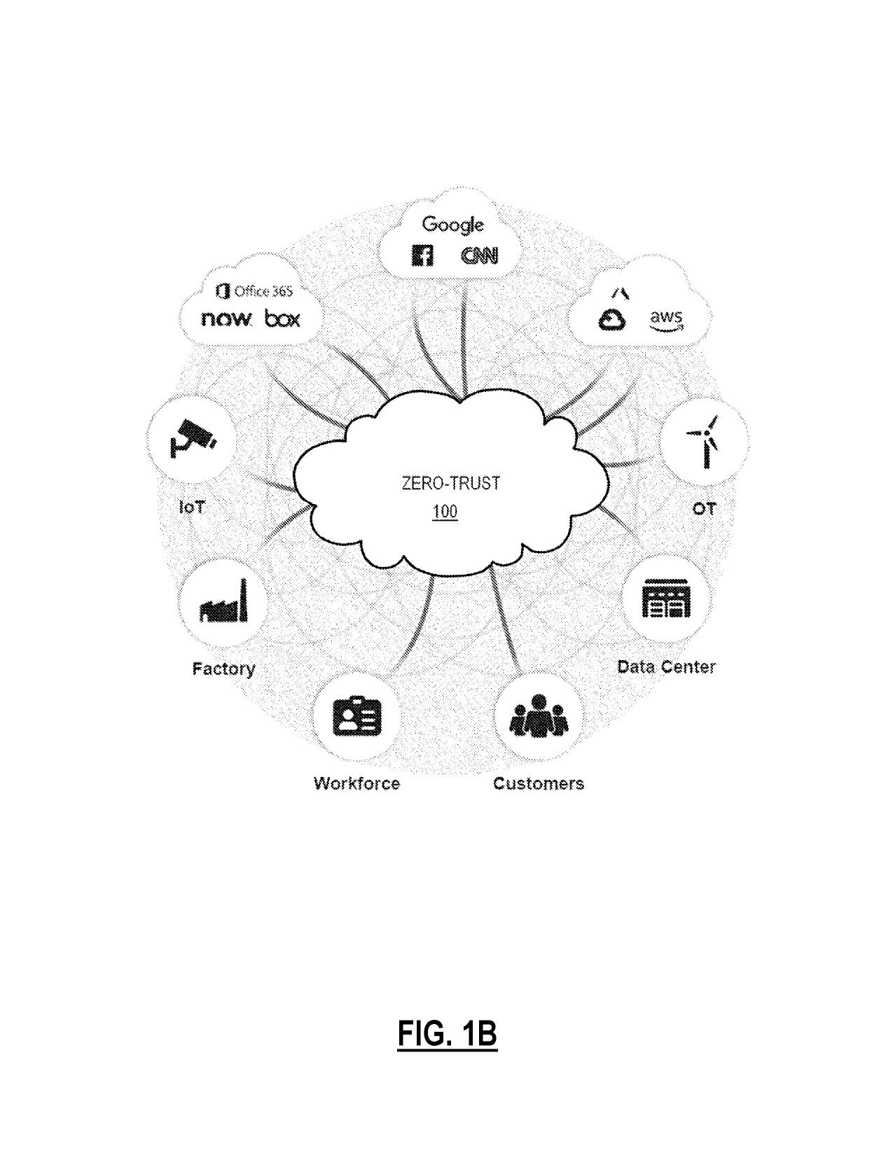

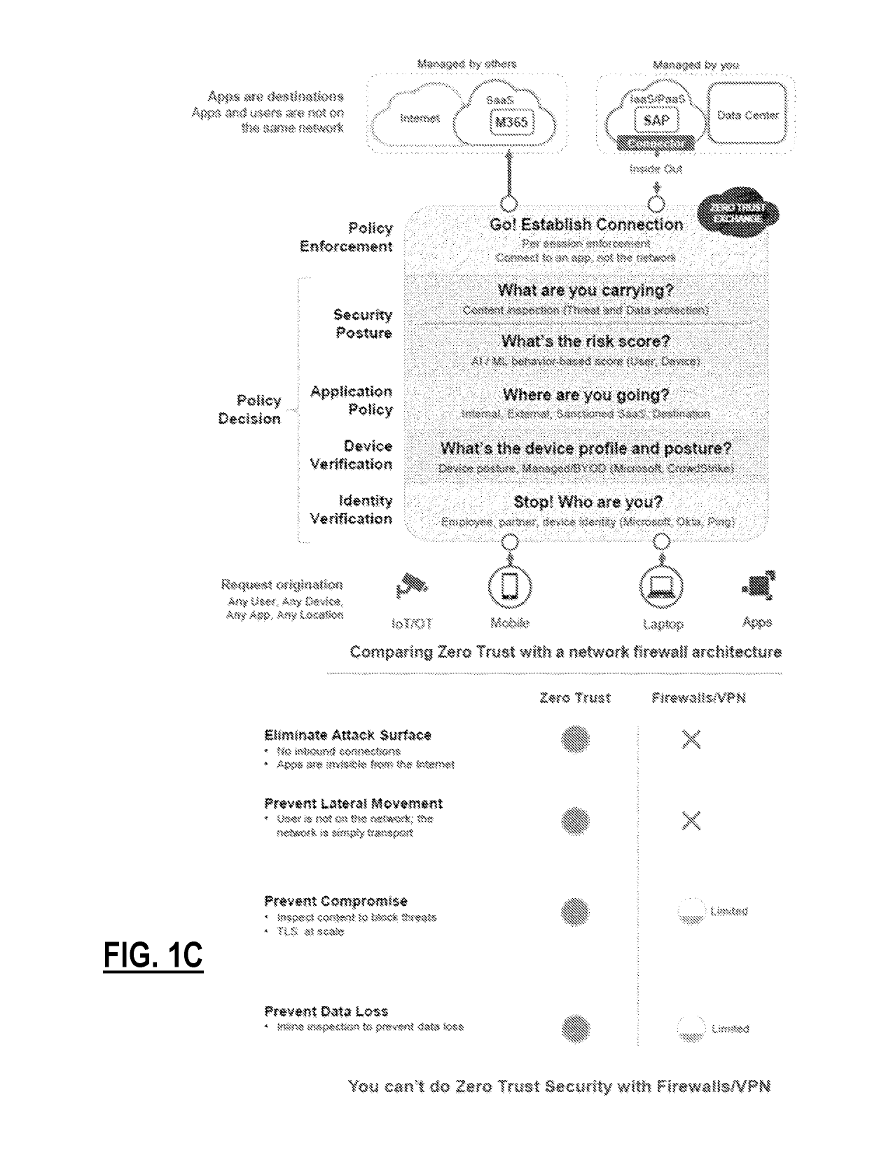

FIG. 1A is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including SSL/TLS traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

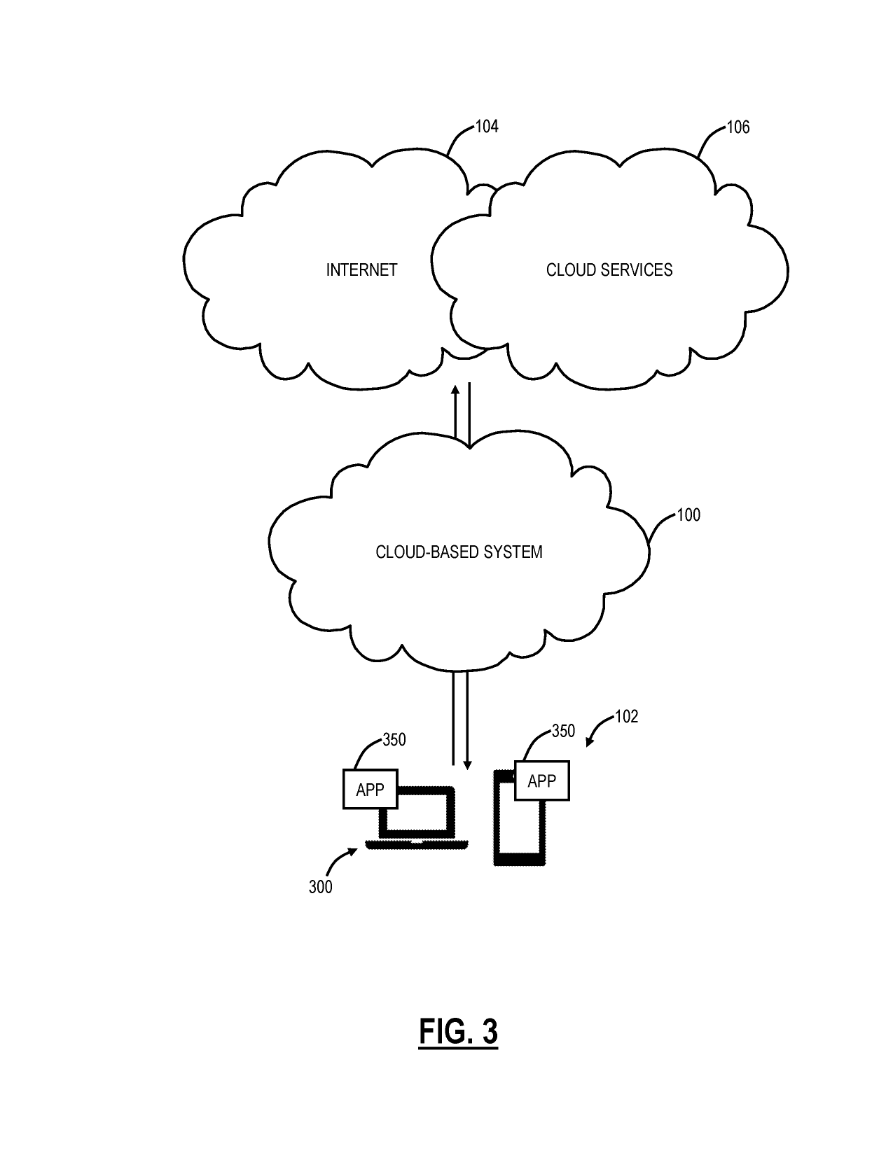

For illustration purposes, the users 102 of the cloud-based system 100 can include a mobile device 110, a headquarters (HQ) 112 which can include or connect to a data center (DC) 114, Internet of Things (IoT) devices 116, a branch office 118, etc., and each includes one or more user devices (an example user device 300 is illustrated in FIG. 3). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise’s network with resources in the data center 114. The mobile device 110 can be a so-called road warrior, i.e., users that are off-site, on-the-road, etc.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes – they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 106) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) for authentication of the users 102 and to a Security Information and Event Management (SIEM) system for event logging. The SIEM system 124 can provide alert and activity logs on a per-user 102 basis.

### Zero Trust

FIG. 1B is a logical diagram of the cloud-based system 100 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud-based system 100. Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud-based system 100. Critically, in a zero trust architecture, a resource's network location is not the biggest factor in its security posture anymore. Instead of rigid network segmentation, your data, workflows, services, and such are protected by software-defined microsegmentation, enabling you to keep them secure anywhere, whether in your data center or in distributed hybrid and multicloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
1) Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination-to prevent ransomware, malware, and more.
2) Protect data using granular context-based policies: Zero trust policies verify access requests and rights based on context, including user identity, device, location, type of content, and the application being requested. Policies are adaptive, so user access privileges are continually reassessed as context changes.
3) Reduce risk by eliminating the attack surface: With a zero trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

FIG. 1C is a logical diagram illustrating zero trust policies with the cloud-based system 100 and a comparison with the conventional firewall-based approach. Zero trust with the cloud-based system 100 allows per session policy decisions and enforcement regardless of the user 102 location. Unlike the conventional firewall-based approach, this eliminates attack surfaces, there are no inbound connections; prevents lateral movement, the user is not on the network; prevents compromise, allowing encrypted inspection; and prevents data loss with inline inspection.

### Example Implementation of the Cloud-Based System

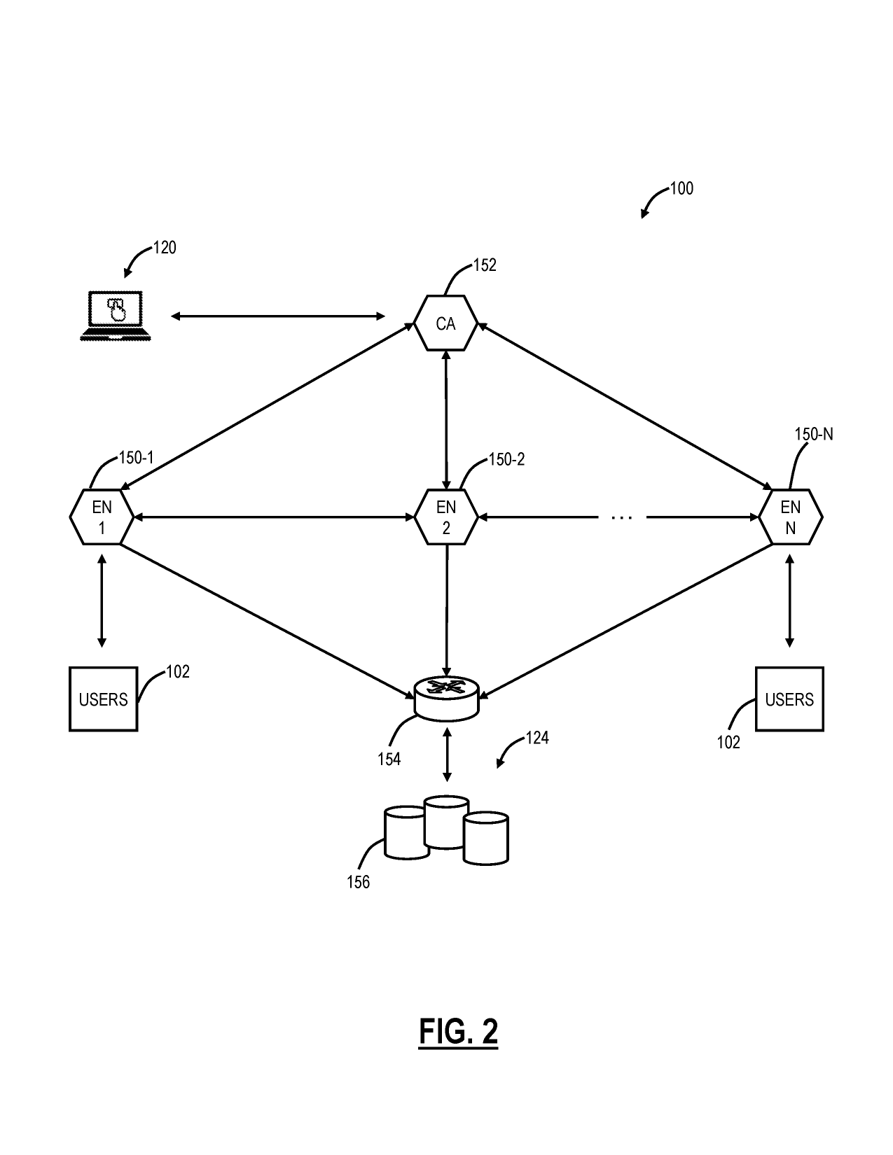

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150, 152, while described as nodes, can include one or more servers, including physical servers, virtual machines (VM) executed on physical hardware, etc. An example of a server is illustrated in FIG. 2. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150. It should be understood that, for purposes of the present disclosure, the term “processing node” may be used interchangeably with or in reference to the enforcement nodes 150. Also, the terms "processing” and “enforcement” are not meant to limit the functionality of such nodes in the cloud-based system 100.

The enforcement nodes 150 are full-featured secure internet gateways that provide integrated internet security. They inspect all web traffic bi-directionally for malware and enforce security, compliance, and firewall policies, as described herein. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure TLS connections to the log routers 154 that direct the logs to the storage cluster 156, hosted in the appropriate geographical region, for each organization.

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 in order to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

Once downloaded, a tenant’s policy is cached until a policy change is made in the management system 120. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company’s on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources in lieu of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### User Device Application for Traffic Forwarding and Monitoring

FIG. 3 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best in class security with zero trust access to internal apps. As described herein, the application 350 can also be referred to as a connector application.

The application 350 is configured to auto-route traffic for seamless user experience. This can be protocol as well as application-specific, and the application 350 can route traffic with a nearest or best fit enforcement node 150. Further, the application 350 can detect trusted networks, allowed applications, etc. and support secure network access. The application 350 can also support the enrollment of the user device 300 prior to accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPSec VPN, authentication cookies, or user 102 setup.

### Example server architecture

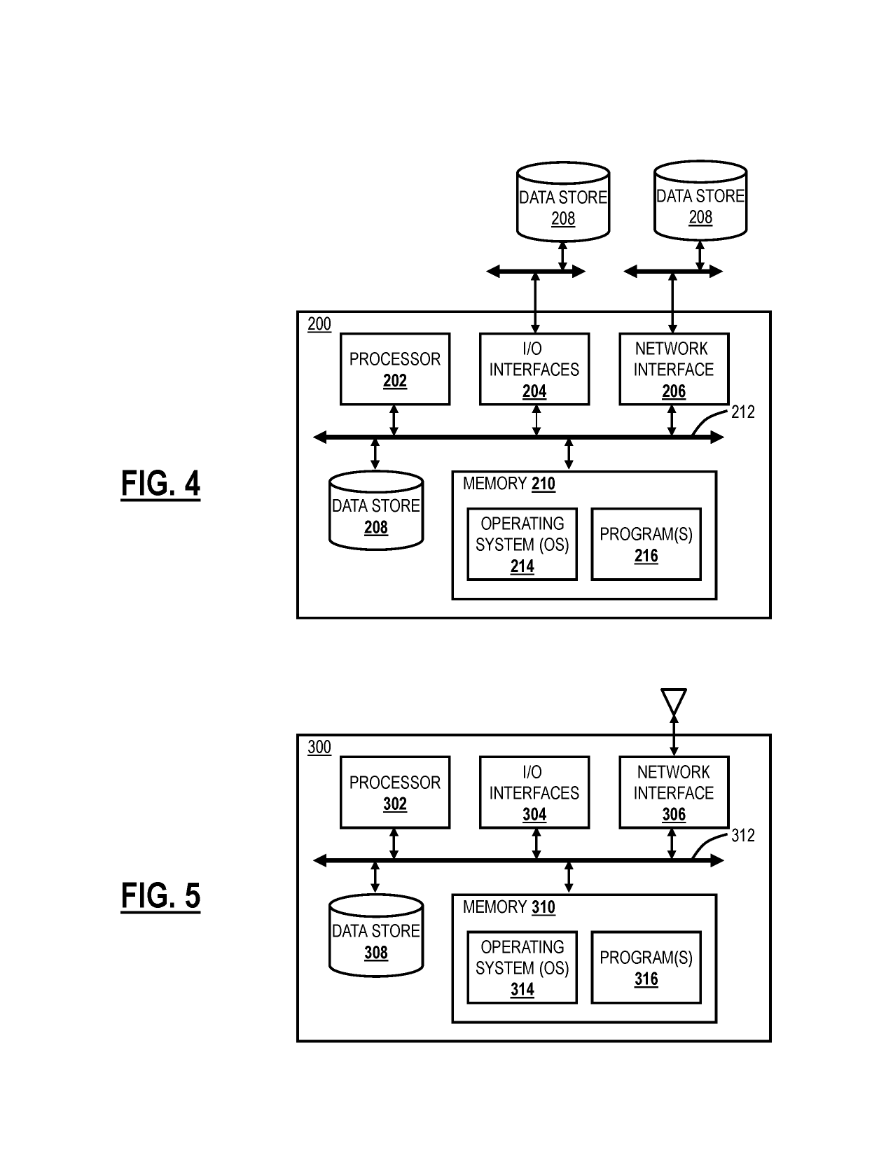

FIG. 4 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the programs 216, and provides scheduling, input-output control, file and data management, memory management, and communication control and related services. The one or more programs 216 may be configured to implement the various processes, algorithms, methods, techniques, etc. described herein.

### Example user device architecture

FIG. 5 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### Cloud Tunnel

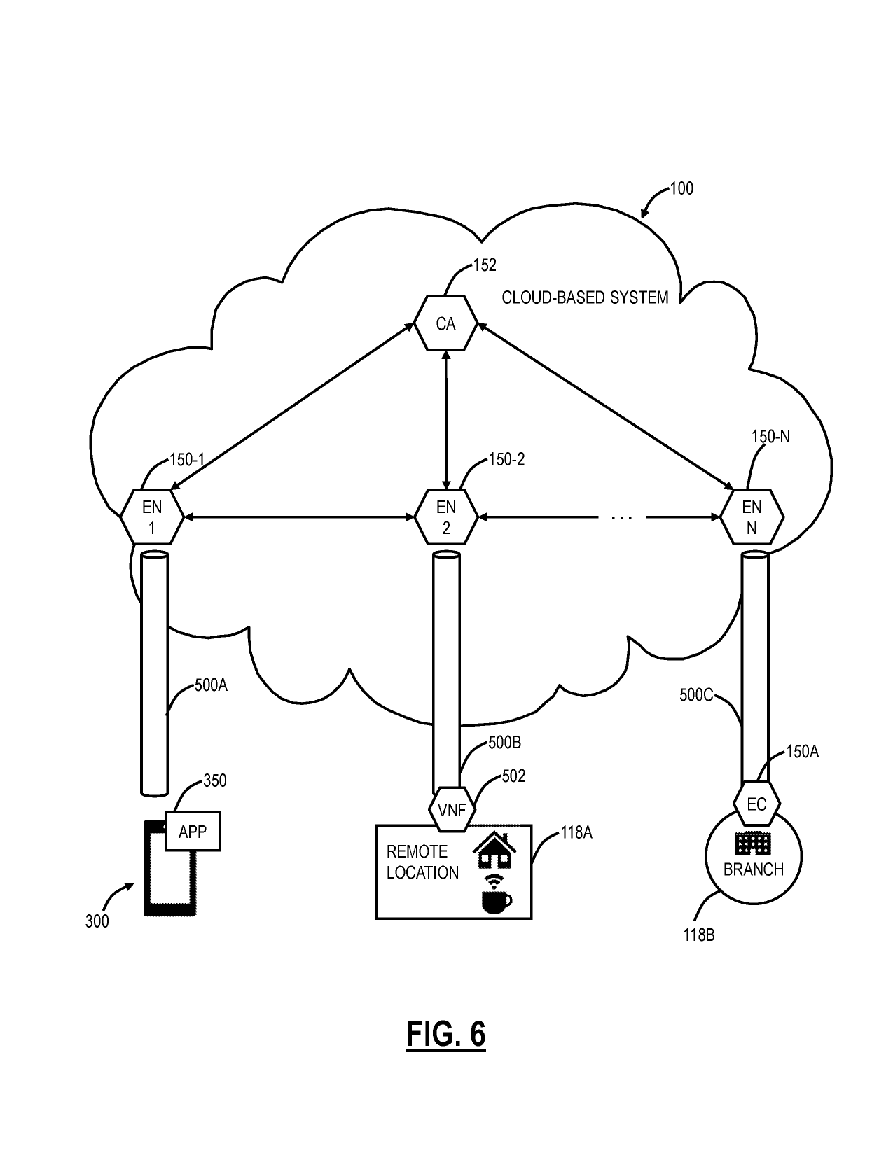

FIG. 6 is a network diagram of the cloud-based system 100 with various cloud tunnels 500, labeled as cloud tunnels 500A, 500B, 500C, for forwarding traffic. The cloud tunnel 500 is a lightweight tunnel that is configured to forward traffic between the user devices 300 and the processing nodes 150. Those skilled in the art will recognize the cloud tunnel 500 can be used with the cloud-based system 100 as an example use case, and other uses are contemplated. That is, the user devices 300 and the processing nodes 150 are just endpoint devices that support the exchange of data traffic and control traffic for the tunnel 500. For description, the enforcement nodes 150 can be referred to as local nodes (or processing nodes) and the user devices 300 as remote nodes, where the tunnel operates between the local and remote nodes.

In an embodiment, the cloud-based system 100 can use the cloud tunnel 500 to forward traffic to the enforcement nodes 150, such as from a user device 300 with the application 350, from a branch office/remote location 118, etc. FIG. 6 illustrates three example use cases for the cloud tunnel 500 with the cloud-based system 100, and other uses are also contemplated. In a first use case, a cloud tunnel 500A is formed between a user device 300, such as with the application 350, and an enforcement node 150-1. For example, when a user 102 associated with the user device 300 connects to a network, the application 350 can establish the cloud tunnel 500A to the closest or best enforcement node 150-1, and forward the traffic through the cloud tunnel 500A so that the enforcement node 150-1 can apply the appropriate security and access policies. Here, the cloud tunnel 500A supports a single user 102, associated with the user device 300.

In a second use case, a cloud tunnel 500B is formed between a Virtual Network Function (VNF) 502 or some other device at a remote location 118A and an enforcement node 150-2. Here, the VNF 502 is used to forward traffic from any user 102 at the remote location 118A to the enforcement node 150-2. In a third use case, a cloud tunnel 110C is formed between an on-premises enforcement node, referred to as an Edge Connector (EC) 150A, and an enforcement node 150-N. The edge connector 150A can be located at a branch office 118B or the like. In some embodiments, the edge connector 150A can be an enforcement node 150 in the cloud-based system 100 but located on-premises with a tenant. Here, in the second and third use cases, the cloud tunnels 500B, 500C support multiple users 102.

There can be two versions of the cloud tunnel 500, referred to a tunnel 1 and tunnel 2. The tunnel 1 can only support Web protocols as an HTTP connect tunnel operating on a TCP streams. That is, the tunnel 1 can send all proxy-aware traffic or port 80/443 traffic to the enforcement node 150, depending on the forwarding profile configuration. This can be performed via CONNECT requests, similar to a traditional proxy.

The tunnel 2 can support multiple ports and protocols, extending beyond only web protocols. As described herein, the cloud tunnels 500 are the tunnel 2. In all of the use cases, the cloud tunnel 500 enables each user device 300 to redirect traffic destined to all ports and protocols to a corresponding enforcement node 150. Note, the cloud-based system 100 can include load balancing functionality to spread the cloud tunnels 500 from a single source IP address. The cloud tunnel 500 supports device logging for all traffic, firewall, etc., such as in the storage cluster 156. The cloud tunnel 500 utilizes encryption, such as via TLS or DTLS, to tunnel packets between the two points, namely the users 102 and the server 200. As described herein, the users 102 can be the user device 300, the VNF 502, and/or the edge connector 150A, and the server 200 can be the enforcement node 150. Again, other devices are contemplated with the cloud tunnel 500.

The cloud tunnel 500 can use a Network Address Translation (NAT) device that does not require a different egress IP for each device's 300 separate sessions. Again, the cloud tunnel 500 has a tunneling architecture that uses DTLS or TLS to send packets to the cloud-based system 100. Because of this, the cloud tunnel 500 is capable of sending traffic from all ports and protocols.

Thus, the cloud tunnel 500 provides complete protection for a single user 102, via the application 350, as well as for multiple users at remote locations 118, including multiple security functions such as cloud firewall, cloud IPS, etc. The cloud tunnel 500 includes user-level granularity of the traffic, enabling different users 102 on the same cloud tunnel 500 for the enforcement nodes 150 to provide user-based granular policy and visibility. In addition to user-level granularity, the cloud tunnel 500 can provide application-level granularity, such as by mapping mobile applications (e.g., Facebook, Gmail, etc.) to traffic, allowing for app-based granular policies.

### Geographic Internet Protocol (IP) address brokering

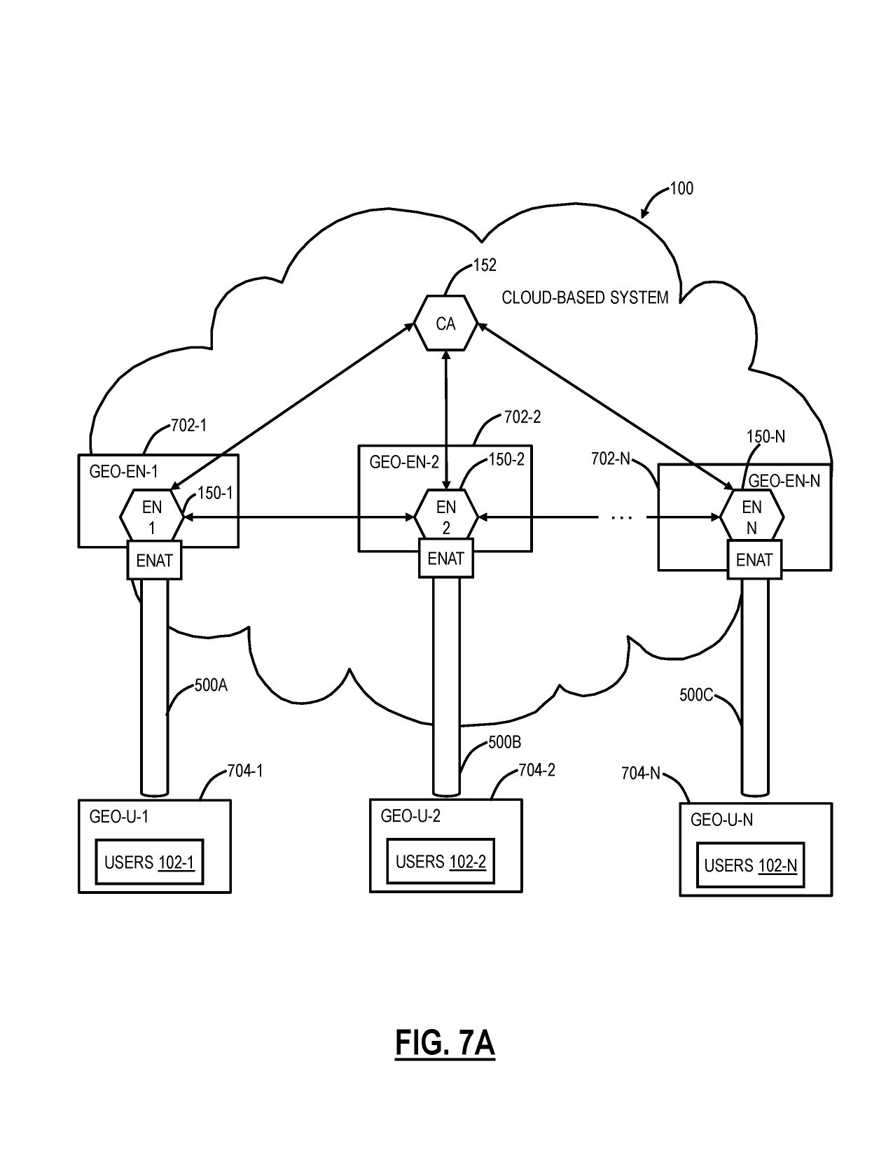

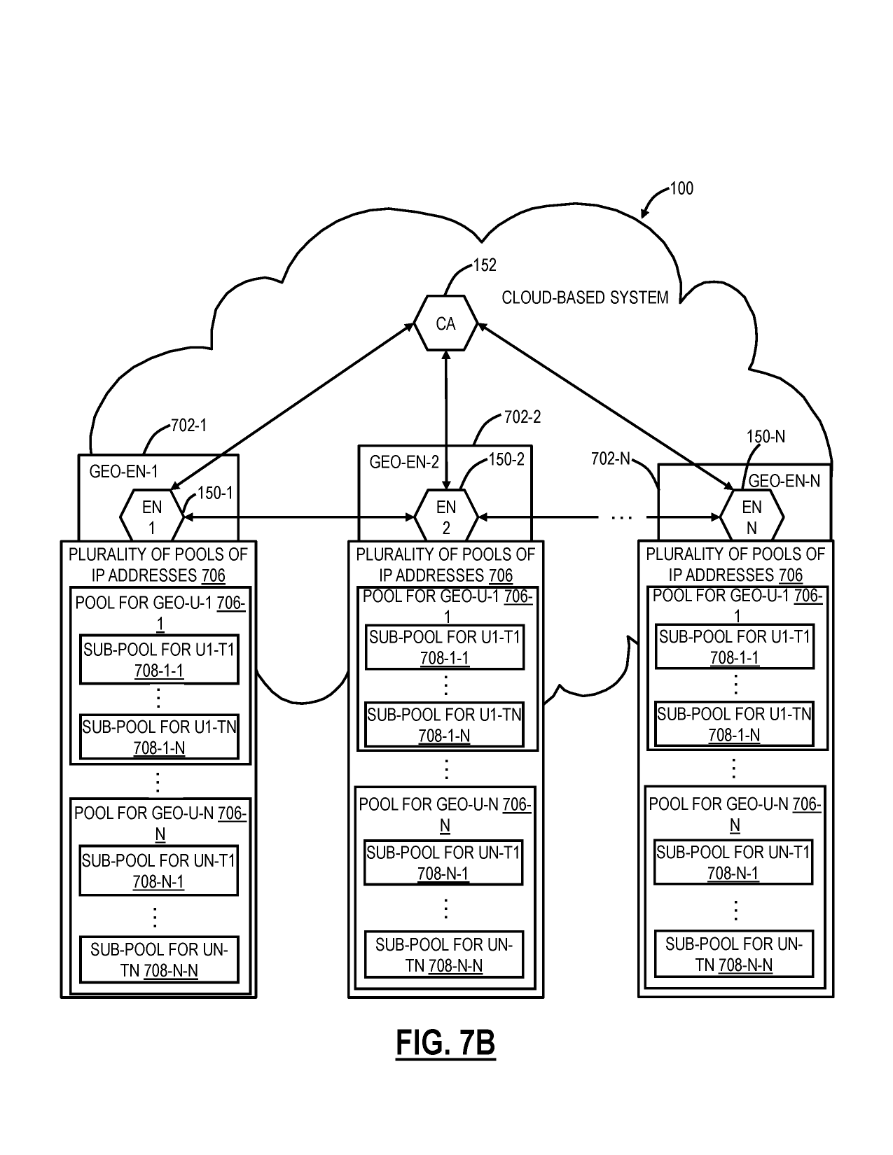

FIG. 7A is a network diagram illustrating multiple geographically distributed enforcement nodes 150 of the cloud-based system 100 and respective geographic regions associated with users 102 connected thereto. As shown, the cloud-based system 100 includes the central authority (CA) 152 and the plurality of enforcement nodes (ENs) 150-1, 150-2, 150-N, each of which is associated with a respective geographic region labeled GEO-EN-1, GEO-EN-2, through GEO-EN-N, respectively, and is denoted with reference numerals 702-1, 702-2, through 702-N. Each enforcement node 150 is configured to broker network access on behalf of the users 102 based on region-specific policies and IP address assignments, as described herein. These enforcement nodes 150 are configured to process traffic for the users 102 located in various geographic regions labeled as GEO-U-1, GEO-U-2, through GEO-U-N, which are represented in FIG. 7A by reference numerals 704-1, 704-2, through 704-N.

In this configuration, each enforcement node 150 is positioned within its respective geographic enforcement region (e.g., GEO-EN-1) and includes a corresponding ENAT device configured for inline traffic inspection and source IP address reassignment. The cloud-based system 100 also includes the central authority (CA) 152, which communicates with each enforcement node 150 using control links, allowing policy distribution and synchronization across enforcement nodes 150.

Traffic from the users 102-1, 102-2, through 102-N, located in geographic user regions GEO-U-1, GEO-U-2, through GEO-U-N, respectively, is forwarded to the cloud-based system 100 through the tunnels labeled as 500A, 500B, and 500C. These tunnels 500 terminate at the respective enforcement nodes 150, where traffic is inspected, and policies are enforced based on user identity, tenant, and contextual attributes derived from the request.

Each enforcement node 150 of the cloud-based system 100 is configured to broker access requests from the users 102 to network resources. Upon receiving a request to access the network resource, the enforcement node 150 evaluates associated request metadata and contextual information to determine the geographic region 704 corresponding to the user 102. This determination may be based on several factors, including the source public IP address of the request, DNS resolution origin, known user-to-region mappings stored during previous session interactions or tenant provisioning, and client-reported context via applications 350 or identity management systems. In some embodiments, this geographic association is pre-established as part of the user 102 or tenant registration process and retained within the cloud-based system 100.

Based on the determined geographic region 704 of the user 102, the enforcement node 150 selects an IP address from a pool of IP addresses registered specifically to the determined geographic region 704. This selection step includes identifying a particular IP address from the geographic IP pool corresponding precisely to the determined geographic region 704 of the user 102. Although the selected IP address is from the same geographic region 704 as the user 102, it is distinct and different from original source IP address associated with the user device 300 from where the request originated. Following the selection of the IP address from the pool of IP addresses, the ENAT device associated with the enforcement node 150 performs a translation operation, specifically translating the original source IP address associated with the request from the user 102 to the newly selected IP address from the pool of IP addresses. Consequently, when the enforcement node 150 sends the request toward the network resource, the outgoing request traffic is represented as originating from the selected IP address, which accurately reflects the geographic region 704 associated with the user 102. This selection and translation procedure ensures accurate geographic consistency between the apparent source of the request and the user's original geographic location, despite the geographic region 702 of the enforcement node 150 processing the request being geographically distinct.

Through this architecture, the cloud-based system 100 achieves region-specific brokering, enabling compliant and localized access to geographically restricted content and services while maintaining centralized security enforcement capabilities. This resolves the mismatch issues between user origin and processing location, as discussed previously, and allows enterprises to uphold regional data governance requirements and end-user localization expectations.

In an example, the user 102-1 can be located in the GEO-U-1 704-1 (Let’s say Bahamas) wishes to access an e-commerce website to purchase a mattress. Initially, the user's device 300 establishes the cloud tunnel 500A to the enforcement node 150-1 situated in the GEO-EN-1 702-1, chosen based on geographic proximity and network performance criteria. Upon receiving the user's request at the enforcement node 150-1, it evaluates request metadata, determines the geographic region 704-1 (the Bahamas), and subsequently selects an IP address (for example, 24.51.111.5) from the address pool registered to the Bahamas (e.g., 24.51.111.0/24).

Although this selected IP address 24.51.111.0/24 belongs to the GEO-U-1 704-1 (Bahamas) as the user's original location, it is distinct from the user’s original source IP address (Let’s say 24.51.125.0/20). The ENAT device co-located with the enforcement node 150-1 then translates the original source IP address 24.51.125.0/20 to the newly selected IP address 24.51.111.0/24, ensuring that the e-commerce website perceives the request as originating locally within the Bahamas. Consequently, when the e-commerce website processes the request, it delivers localized content such as product listings, pricing, and relevant advertisements for local mattress retailers in the Bahamas, significantly improving the user experience through accurate geographic alignment.

In another example, the user 102-2 can be located in the geographic region 704-2 (Let’s say Germany) to access a government-operated healthcare portal restricted to IP addresses originating within Germany. The user's request is routed via the cloud tunnel 500B to the enforcement node 150-2, positioned in the geographic region 702-2 (Let’s say Netherlands). Despite the geographic difference, the enforcement node 150-2 accurately determines the geographic region 704-2 as Germany, through metadata analysis and selects the IP address from the pool of IP addresses registered specifically to Germany. The ENAT device at the enforcement node 150-2 then performs IP address translation, thus presenting the request as originating within Germany. This approach ensures seamless access to critical resources governed by geographic compliance requirements.

FIG. 7B is a block diagram illustrating a plurality of pools of IP addresses 706 maintained at each enforcement node 150. Specifically, each enforcement node 150-1, 150-2, through 150-N maintains multiple distinct pools of IP addresses 706-1 through 706-N, each registered to the geographic region GEO-U-1 through GEO-U-N. Within each pool 706, there are tenant-specific sub-pools labeled as 708-1-1 through 708-1-N, and correspondingly through 708-N-1 to 708-N-N. These tenant-specific sub-pools enable the enforcement nodes 150 to select IP addresses based not only to geographic alignment but also to specific tenants, thereby supporting granular policy management and isolation within multi-tenant environments.

For example, the sub‑pool 708‑1‑1 may be reserved for Tenant T1 in the GEO‑U‑1, while the sub‑pool 708‑1‑N is reserved for Tenant TN in the same geographic region. This partitioning of the pools 706 achieves two objectives that correspond directly to ensuring that no tenant accidentally can inadvertently originate traffic on an IP address allocated to another tenant, thereby preserving policy isolation and allowing the cloud‑based system 100 to apply geographic region and tenant scoped controls such as data‑sovereignty limits, custom logging rules, or rate‑limiting thresholds.

In an example, the enforcement node 150-1, positioned in the geographic enforcement region GEO-EN-1 702-1 services the users 102-1 located in the geographic region GEO-U-1 704-1 due to the geographic proximity. Within the pool 706-1, the cloud-based system 100 allocates the sub-pool 708-1-1 to Tenant T1 and the sub-pool 708-1-N to Tenant TN, while any remaining tenants in the users 102-1 receive their own respective sub-pools. When a user belonging to the users 102 establishes the cloud tunnel 500 to the enforcement node 150 and transmits the request to access the network resource, the enforcement node 150 determines whether the user is associated with the Tenant T1 and with the geographic region 704-1. Responsive to the determination that the user is associated both with the Tenant T1 and with the geographic region GEO-U-1 704-1, the enforcement node 150-1 selects the Internet-Protocol address from the sub-pool 708-1-1, that the sub-pool 708-1-1 having been dedicated exclusively to the Tenant T1 within the pool 706-1. The ENAT device co-located with the enforcement node 150-1 subsequently performs an egress network-address-translation operation that substitutes the original source IP address of the request with the selected IP address. As a result, the request is forwarded toward the network resource as traffic that appears to originate from an address geolocated to the geographic region 704-1 and is uniquely attributable to the Tenant T1, thereby enabling downstream servers to apply region-specific content rules while the cloud-based system 100 maintains tenant-scoped auditing, rate-limiting, and compliance policies.

After the ENAT device of the enforcement node 150 substitutes the original source IP address with the selected IP address drawn from the pool 706, the enforcement node 150 brokers a connection to the network resource by transmitting the request across its public-facing interface using the selected IP address. Return traffic generated by the network resource is routed back toward the geographic region 702 and therefore arrives at the enforcement node 150 addressed to the selected IP address. The enforcement node 150 intercepts inbound packets, reverses IP address translation, encapsulates the packets into tunnel 500, and forwards the return traffic to the users 102.

In an example, when the central authority 152 detects that the enforcement node 150-1 in the geographic region 702-1 has failed or become unavailable, the central authority 152 transmits a control message to an endpoint connector (not shown) instructing it to re-establish a tunnel 500 to a new enforcement node 150. Upon receipt of the rerouted request, the new enforcement node 150 performs determining the geographic region 704 of the users 102, selecting the IP address registered to the geographic region 704 of the users 102, and brokering the connection to the network resource by transmitting the request using the selected IP address as the source IP address.

### Cloud-based geographic internet protocol (IP) address brokering process

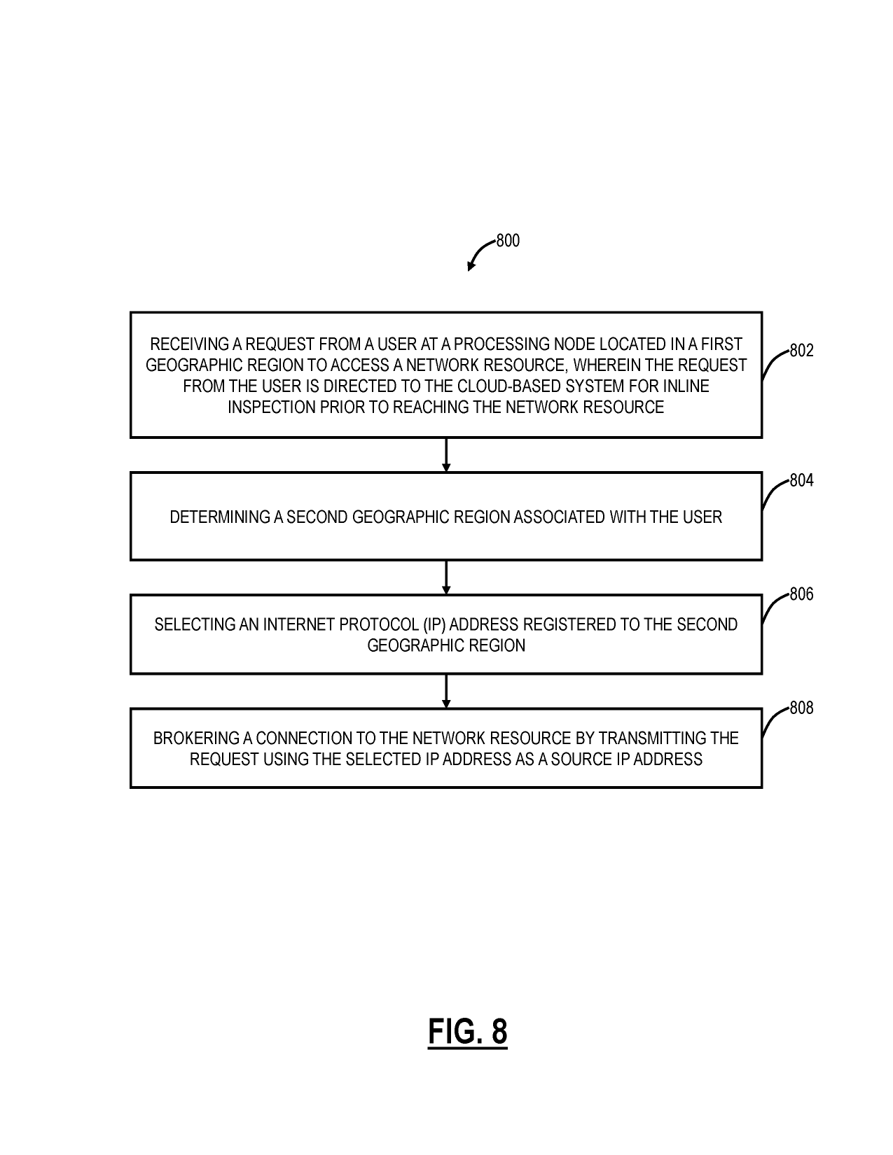

FIG. 8 is a flow chart of a process for cloud-based geographic internet protocol (IP) address brokering process. In various embodiments, the process 800 can be contemplated as a method having steps, a processing device configured to implement the steps, a cloud-based system configured to implement the steps, and as a non-transitory computer-readable medium storing instructions for programming one or more processors to execute the steps. The process 800 includes receiving, at a processing node located in a first geographic region, a request from a user to access a network resource, wherein the request from the user is directed to the cloud-based system for inline inspection prior to reaching the network resource (step 802); determining a second geographic region associated with the user (step 804); selecting an internet protocol (IP) address registered to the second geographic region (step 806); and brokering a connection to the network resource by transmitting the request using the selected IP address as a source IP address (step 808).

The processing node can be selected by the cloud-based system to receive the request based on geographic proximity between the processing node and the user. The determining can include evaluating an original source internet protocol (IP) address associated with the request from the user. The determining can include evaluating an original source internet protocol (IP) address associated with the request from the user. The IP address can be selected from a pool of IP addresses, wherein each IP address in the pool is registered to a geographic region. The pool of IP addresses can include tenant-specific sub-pools, and the IP address can be selected from a tenant-specific sub-pool based on an identifier associated with the user. The selected IP address can be hosted at the processing node in the first geographic region, wherein the first geographic region is different from the second geographic region. The process 800 can further include intercepting, by the processing node, return traffic from the network resource addressed to the selected IP address; and forwarding the intercepted return traffic to the user. The process 800 can further include maintaining, by the cloud-based system, a plurality of pools of internet protocol (IP) addresses, wherein each IP address from the plurality of pools is registered to a respective geographic region prior to receiving the request from the user. The process 800 can further include performing, by the processing node, an egress network address translation (NAT) to substitute the original source IP address associated with the request from the user and corresponding to the second geographic region with the selected IP address registered to the second geographic region, prior to brokering the connection to the network resource. The process 800 can further include rerouting the request to a new processing node upon failure or unavailability of the processing node, wherein the new processing node performs the determining, selecting, and brokering.

### Conclusion

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, processor, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method implemented by a cloud-based system, the method comprising steps of:
receiving, at a processing node located in a first geographic region, a request from a user to access a network resource, wherein the request from the user is directed to the cloud-based system for inline inspection prior to reaching the network resource;
determining a second geographic region associated with the user;
selecting an internet protocol (IP) address registered to the second geographic region; and
brokering a connection to the network resource by transmitting the request using the selected IP address as a source IP address.

2. The method of claim 1, wherein the processing node is selected by the cloud-based system to receive the request based on geographic proximity between the processing node and the user.

3. The method of claim 1, wherein the determining includes evaluating an original source internet protocol (IP) address associated with the request from the user.

4. The method of claim 1, wherein the IP address is selected from a pool of IP addresses, wherein each IP address in the pool is registered to a geographic region.

5. The method of claim 4, wherein the pool of IP addresses includes tenant-specific sub-pools, and wherein the IP address is selected from a tenant-specific sub-pool based on an identifier associated with the user.

6. The method of claim 1, wherein the selected IP address is hosted at the processing node in the first geographic region, wherein the first geographic region is different from the second geographic region.

7. The method of claim 1, wherein the steps further include:
intercepting, by the processing node, return traffic from the network resource addressed to the selected IP address; and
forwarding the intercepted return traffic to the user.

8. The method of claim 1, wherein the steps further include maintaining, by the cloud-based system, a plurality of pools of internet protocol (IP) addresses, wherein each IP address from the plurality of pools is registered to a respective geographic region prior to receiving the request from the user.

9. The method of claim 1, wherein the steps further include performing, by the processing node, an egress network address translation (NAT) to substitute an original source internet protocol (IP) address associated with the request from the user and corresponding to the second geographic region with the selected IP address registered to the second geographic region, prior to brokering the connection to the network resource.

10. The method of claim 1, wherein the steps further include rerouting the request to a new processing node upon failure or unavailability of the processing node, wherein the new processing node performs the determining, selecting, and brokering.

11. A non-transitory computer-readable storage medium having computer-readable code stored thereon for programming one or more processors of a cloud-based system to perform steps of:
receiving, at a processing node located in a first geographic region, a request from a user to access a network resource, wherein the request from the user is directed to the cloud-based system for inline inspection prior to reaching the network resource;
determining a second geographic region associated with the user;
selecting an internet protocol (IP) address registered to the second geographic region; and
brokering a connection to the network resource by transmitting the request using the selected IP address as a source IP address.

12. The non-transitory computer-readable storage medium of claim 11, wherein the processing node is selected by the cloud-based system to receive the request based on geographic proximity between the processing node and the user.

13. The non-transitory computer-readable storage medium of claim 11, wherein the determining includes evaluating an original source internet protocol (IP) address associated with the request from the user.

14. The non-transitory computer-readable storage medium of claim 11, wherein the IP address is selected from a pool of IP addresses, wherein each IP address in the pool is registered to a geographic region.

15. The non-transitory computer-readable storage medium of claim 14, wherein the pool of IP addresses includes tenant-specific sub-pools, and wherein the IP address is selected from a tenant-specific sub-pool based on an identifier associated with the user.

16. The non-transitory computer-readable storage medium of claim 11, wherein the selected IP address is hosted at the processing node in the first geographic region, wherein the first geographic region is different from the second geographic region.

17. The non-transitory computer-readable storage medium of claim 11, wherein the steps further include:
intercepting, by the processing node, return traffic from the network resource addressed to the selected IP address; and
forwarding the intercepted return traffic to the user.

18. The non-transitory computer-readable storage medium of claim 11, wherein the steps further include maintaining, by the cloud-based system, a plurality of pools of internet protocol (IP) addresses, wherein each IP address from the plurality of pools is registered to a respective geographic region prior to receiving the request from the user.

19. The non-transitory computer-readable storage medium of claim 11, wherein the steps further include performing, by the processing node, an egress network address translation (NAT) to substitute an original source internet protocol (IP) address associated with the request from the user and corresponding to the second geographic region with the selected IP address registered to the second geographic region, prior to brokering the connection to the network resource.

20. The non-transitory computer-readable storage medium of claim 11, wherein the steps further include rerouting the request to a new processing node upon failure or unavailability of the processing node, wherein the new processing node performs the determining, selecting, and brokering.
